(19) United States
(12) Patent Application Publication
(10) Pub. No.: US 2026/0127198 A1
(43) Pub. Date: May 7, 2026

(54) INFORMATION PROVISION SYSTEM, INFORMATION PROVISION METHOD, AND RECORDING MEDIUM

(71) Applicant: CASIO COMPUTER CO., LTD., Tokyo (JP)

(72) Inventor: Kosuke MATSUMOTO, Tokyo (JP)

(73) Assignee: CASIO COMPUTER CO., LTD., Tokyo (JP)

(21) Appl. No.: 19/379,847

(22) Filed: Nov. 5, 2025

(30) Foreign Application Priority Data
Nov. 5, 2024 (JP) 2024-193363

(51) Int. Cl. G06F 16/3329

(52) U.S. Cl. CPC G06F 16/33295

(57) ABSTRACT

An information provision system includes a processor. The processor identifies a group to which a user belongs, based on characteristic information of the user. The processor determines external knowledge data corresponding to the identified group. The processor obtains a response content for responding to an input content by the user from the determined external knowledge data. The processor inputs the obtained response content to a machine learning model to generate a response to the user.

### REFERENCE TO RELATED APPLICATIONS

This application is based upon and claims the benefit of priority from the prior Japanese Patent Application No. 2024-193363, filed on November 5, 2024, the entire contents of which are incorporated herein by reference.

### BACKGROUND OF THE INVENTION

### TECHNICAL FIELD

The present disclosure relates to an information provision system, an information provision method, and a recording medium.

### DESCRIPTION OF RELATED ART

The use of artificial intelligence (AI) as a machine learning model has been increasingly adopted in an information provision system that outputs advice or answers to questions for users who perform various activities. As an example of an information provision system using AI, Japanese published unexamined patent application No. 2019-56970 discloses a technology of preparing multiple AIs, selecting an optimum AI based on user-related information, and generating and outputting answers.

### SUMMARY OF THE INVENTION

According to the present disclosure, an information provision system includes a processor that: identifies a group to which a user belongs, based on characteristic information of the user, determines external knowledge data corresponding to the identified group, obtains a response content for responding to an input content by the user from the determined external knowledge data, and inputs the obtained response content to a machine learning model to generate a response to the user.

### BRIEF DESCRIPTION OF DRAWINGS

FIG. 1 is a block diagram showing the functional configuration of an information provision system of an embodiment.

FIG. 2 shows the procedure of generating an answer.

FIG. 3 is a flowchart showing the control procedure of a to-be-provided information generation process.

FIG. 4A shows an example of how answer contents are adjusted.

FIG. 4B shows an example of how answer contents are adjusted.

FIG. 5 is a flowchart showing the control procedure of a cluster setting process.

FIG. 6 is a flowchart showing the control procedure of an answer evaluation process.

FIG. 7 is a flowchart showing the control procedure of a weight adjustment process.

### DETAILED DESCRIPTION

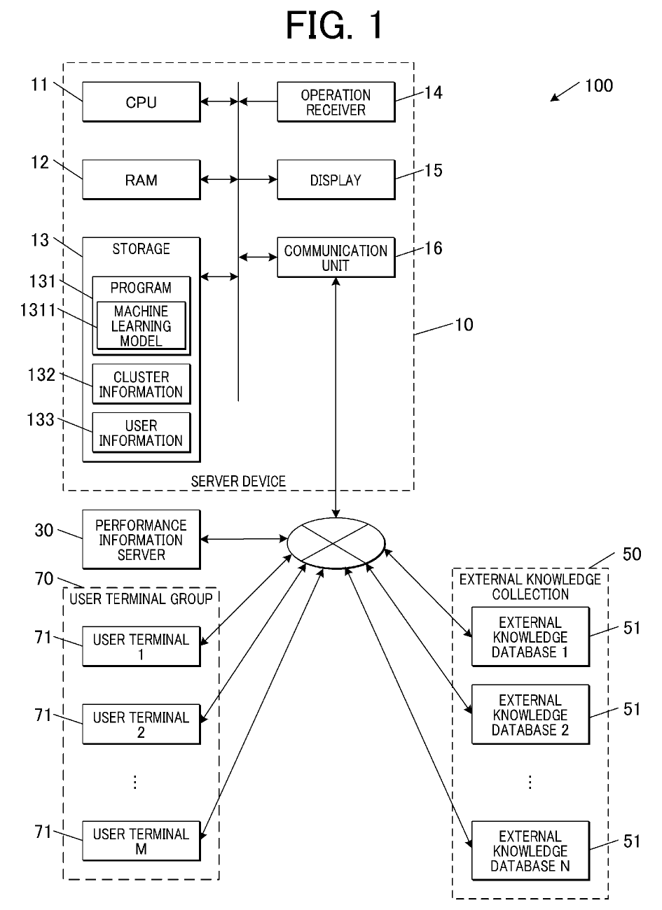

Hereinafter, an embodiment of the present disclosure will be described with reference to the drawings. As shown in the block diagram of FIG. 1, an information provision system 100 includes a server device 10, a performance information server 30, an external knowledge collection 50, and a user terminal group 70. The information provision system 100 provides responses to contents sent from users, specifically answers to questions to clear up questions or improve ability and performance in specific study subjects or specific kinds of activities. The specific kinds of activities include sports (e.g., running) and intellectual games (e.g., Go and Shogi), for example. Users may each have a user terminal 71 belonging to the user terminal group 70. For another example, a user terminal 71 may be shared in a school or a training facility where users are identifiable by sign-in. FIG. 1 shows M user terminals 71 as an example, where “M” may be any number.

The server device 10 generates answers (responses) to questions or the like received on the user terminals 71 in the user terminal group 70 and outputs the answers to the user terminals 71. The performance information server 30 is a database that stores and retains histories of performance and ability scores of users of the user terminals in the subjects or the specific kinds of activities. The performance information server 30 is a server device connected to a network, such as the Internet. The performance information server 30 may be a personal computer (PC). That is, the performance information server 30 includes at least a processor, a memory, and a communication unit and can send and receive data to and from the server device 10 via the network by the communication unit under the control of the processor. The processor may be a general-purpose central processing unit (CPU). The memory includes a nonvolatile memory, such as a hard disk drive (HDD) or a flash memory, on which the histories of performance and ability scores are stored and retained. The database may be a conventionally used database, such as a relational database. For another example, the database may simply store the above contents in association with user identification information as array data. Information on performance and so forth is used to evaluate the use of external knowledge databases 51, which are used to generate answers, as described later. The performance may include results of periodic examinations, qualification/certification examinations, competitions, and individual training. The results of periodic examinations and so forth may be input to the performance information server 30 by a conductor of the periodic examinations different from the users, for example. The results of individual training and so forth may be obtained from the user terminal group 70 automatically or from reporting operations by the users.

The external knowledge collection 50 is one or more electronic devices that electronically store and retain specialized information, which is used by the server device 10 for generating answers. In one embodiment, the external knowledge collection 50 may include multiple external knowledge databases 51 (external knowledge data). For another example, the external knowledge collection 50 may integrally store and retain the specialized information in a single external knowledge database 51 and manage the individual items of the specialized information by the units of documents, chapters, or sections. The external knowledge database 51 is a database device or a system that includes at least a processor, a memory, and a communication unit. The external knowledge database 51 can send and receive data to and from external devices (herein, at least the server device 10) via the communication unit over a network, such as the Internet. The processor may be a general-purpose CPU or may be specifically designed and manufactured for data management. The memory includes a nonvolatile memory, such as an HDD or a flash memory. The nonvolatile memory stores the above data to be managed. As the type of database, a conventional relational database may be used, for example. Text documents may be structured documents or may be documents to which separately generated document information is attached so that classification information, feature information, and so fort are retained by tags or supplementary data. Data management (i.e., updating and adding data) may be performed by an external management device, for example.

The server device 10 includes a CPU 11, a random access memory (RAM) 12, a storage 13, an operation receiver 14, a display 15, and a communication unit 16. The CPU 11 is a processor that performs arithmetic processing and centrally controls operations of the server device 10 as the controller of this embodiment. The CPU 11 may include a single processor. The CPU 11 may include multiple processors and operate them in parallel or independently, depending on the application. The computer of this embodiment includes at least the CPU 11. The RAM 12 provides a working memory space for the CPU 11 and stores temporary data. The RAM 12 may be a dynamic RAM (DRAM), a different kind of RAM, or the combination of multiple kinds of RAM. The storage 13 is a nonvolatile memory that stores a program 131 and various kinds of setting information. The nonvolatile memory may be a flash memory, an HDD, or the like. The program 131 includes a program related to processing of generating answers to questions input by users. The setting information includes cluster information 132 and user information 133, which are described later.

The operation receiver 14 receives input operations by the user and outputs signals corresponding to the received contents to the CPU 11. The operation receiver 14 may include a keyboard and a pointing device (e.g., a mouse), for example. The pointing device may include a touch sensor. The display 15 displays contents under the control of the CPU 11. The display 15 may have a digital display screen, such as a liquid crystal display (LCD), for example. The operation receiver 14 and the display 15 may be peripheral devices connected to the main body of the server device 10. The communication unit 16 controls communications with the outside. The communication unit 16 includes a network card and can send and receive data to and from electronic devices and database devices on an external network over the Internet in accordance with a predetermined communication protocol, for example. These electronic devices and database devices include the performance information server 30, the user terminals 71 in the user terminal group 70, and the external knowledge databases 51 in the external knowledge collection 50. The communication protocol may be limited to wired communication or may include wireless communication.

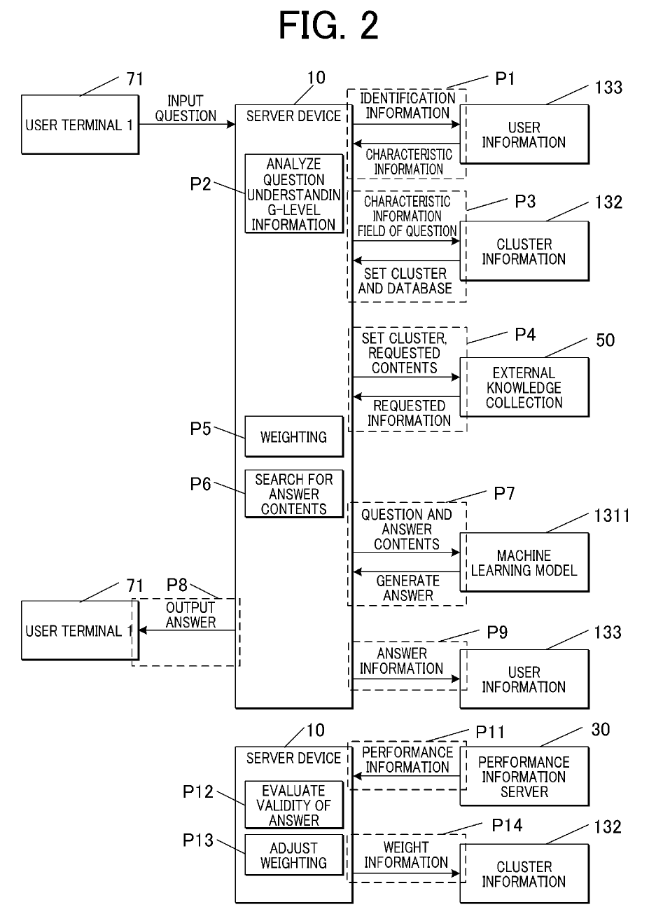

Next, generation of a response is described as the information provision method in this embodiment. When the server device 10 receives an input (e.g., a question) by a user, the server device 10 generates a response to the input (e.g., an answer to the question). The detailedness and plainness of the generated answer may vary depending on the characteristics of the user (characteristic information) and the characteristics of how the question is described, even if the gist of the question is the same. The answer to the question is generated according to the procedure shown in FIG. 2.

The characteristics of the user include at least an ability score of the user in the field corresponding to the question, such as performance and achievements. The characteristics of the user may also include part or all of items declared by the user in user registration, for example. The items to be declared may include favorite subjects, performance such as target scores and achievement hours, a faculty that the user wants to enter, a field in which the user wants work, a qualification that the user wants to obtain, and/or a certification examination that the user wants to pass, for example. The performance may include test scores, the number of mistakes made, and/or the speed or time of completing an assignment, for example. If the provided information relates to activities involving physical movements (e.g., sports), the characteristics of the user may also include biometric information, such as the height, weight, body fat percentage, and pulse rate of the user. The characteristics of the user may also include the history of past inputs by the user. These characteristics of the user are stored and retained as the user information 133 in the storage 13.

The input question is analyzed (e.g., parsed) to identify the field to which the question belongs (the field of the question) (P2). The question is also quantified by being converted into a multidimensional vector. Multidimensional vectorization may be done by query transformations, for example. The query transformations may include multi-queries generation to generate multiple paraphrases of the question or hypothetical document embeddings (HyDE) to generate a provisional answer, for example. The targets of quantification may include not only the contents of the question but also the specificity of the question and how the question has developed from previous related questions. That is, the multidimensional vector may include understanding-level information that indicates how much background knowledge the user has regarding the question and how deeply the user understands the point of the question. If the server device 10 is configured to generate answers in a single field, the field of the question need not be identified. The server device 10 may refer to the user information 133 and obtain a multidimensional vector, based on history information of a predetermined number of most recent questions or questions input during a predetermined period by the user. The server device 10 may compare this multidimensional vector obtained from the history information with the multidimensional vector obtained from the current input contents and determine the degree of similarity between them. If the degree of similarity is high, the server device 10 may determine that the user has repeatedly asked questions having similar or highly related contents. In such a case, the server device 10 may determine whether the user is stumbling at these contents or asking a more advanced related question with deeper understanding, based on the parsing result and so forth. For another example, the server device 10 may obtain the understanding-level information by entering contents of multiple questions to a large language model (LLM) and determining how much the understanding deepened.

The users are grouped into clusters, based on their characteristics in the characteristic information. Various clustering methods using indexes are applicable for division of clusters. The clustering method may be either a hierarchical clustering method or a non-hierarchical clustering method. Examples of hierarchical clustering includes the Ward method. Examples of non-hierarchical clustering includes the k-means method, k-means+, and k-medoids. Clustering is done before questions are received. Therefore, when obtaining the characteristic information of the user, based on the identification information of the user (P1), the server device 10 can determine the cluster to which the user belongs according to the characteristic information (P3). If the server device 10 can generate answers in multiple subjects, fields, and/or progress levels, the server device 10 can determine the clusters (i.e., groups) to which the user belongs for the respective subjects, fields, and/or progress levels. The progress levels may be mechanically classified by school years or ages, for example. The server device 10 selects an appropriate cluster, based on the field of question identified in P2.

The server device 10 obtains data that includes substantive contents (response contents) necessary for generating a response to the input content (herein, data that includes answer contents to the question) from the external knowledge collection 50, as the requested information corresponding to the contents requested by the server device 10 (P4). The external knowledge databases 51 belonging to the external knowledge collection 50 (external knowledge) are information sources the contents of which are ensured to be accurate and reliable. The external knowledge databases 51 are properly maintained and updated as necessary. Especially in advanced technology fields with ongoing knowledge updates and technological innovation, the contents of the external knowledge databases 51 are updated at an appropriate frequency. The external knowledge databases 51 include a database that retains documents containing elementary or basic descriptions and a database that retains documents containing more detailed and advanced descriptions. Further, a document suitable for users who are good at the subject/task and tackling the question content for the first time may belong to a database different from the database of a document suitable for users who are not good at the subject/task and stumbling at the point related to the question content, even if two documents are at the same level. The manager that manages and maintains the external knowledge databases 51 may be different from the manager of the server device 10. Further, different managers may manage and maintain the external knowledge databases 51 in the external knowledge collection 50. For example, the manager of the server device 10 may sign contracts with the managers of the respective external knowledge databases 51 regarding the usage of information so that the server device 10 can use these external knowledge databases 51.

The external knowledge database(s) 51 to obtain data containing response contents is selected according to the cluster to which the user belongs. The information to be obtained from the external knowledge database 51 (i.e., the range of texts) substantially corresponds to the field of the question. The range of texts may be in the units of chapters, sections, or paragraphs of documents, for example. The relation between each cluster and the external knowledge databases 51 selected for the cluster is stored in the cluster information 132.

Multiple external knowledge databases 51 may be selected according to the cluster. The descriptions (information) obtained from the selected external knowledge databases 51 may be assigned weights that are determined for each cluster. That is, in obtaining response contents, the descriptions obtained from the respective external knowledge databases 51 may be assigned different levels of importance by weights (P5). The response contents (answer contents to a question) may be obtained by vector search, based on the question content and the obtained description contents (P6). From the obtained description contents, the server device 10 may extract, as the response contents, a portion that satisfies a required level of cosine similarity with the multidimensional-vectorized question content, for example. The required level as a criterion may be adjusted for each of the external knowledge databases 51 according to the weights.

The server device 10 inputs the response contents (answer contents) obtained and extracted from the external knowledge and the contents (question) input by the user into the machine learning model 1311 to generate a response (answer) (P7). That is, the server device 10 generates a response based on/by using the response contents obtained and extracted from the external knowledge and the contents input by the user. The machine learning model 1311 may be an LLM. Specifically, the machine learning model 1311 may use a transformer. The machine learning model 1311 may be a model trained to analyze questions and generate answers to the questions. Using the technology of retrieval augmentation generation (RAG), which adds external knowledge to a single LLM, can reduce cost of preparing multiple LLMs for the respective knowledge fields.

Since the answer is generated based on the description of the question, each answer can reflect how well the user understands the point of question and how much background knowledge the user has regarding the question. Specifically, if the user is unable to grasp the point of the question or not good at the subject, a sudden detailed answer will not be understood by the user or improve his/her motivation to study. On the other hand, if the user asks a specific question based on basic knowledge, the user is assumed to have a certain level of understanding. In this case, a specific answer is preferable that fills in the lack of understanding and improves understanding. The machine learning model 1311 may be trained to generate answers that reflect the state of understanding of the user in response to input question contents. The answer generated by the machine learning model 1311 is output to the user terminal 71 that sent the question (P8). The information on the response (answer) contents is additionally stored in the user information 133 (P9).

The weights may be readjusted at an appropriate frequency. For the user who asked a question and received the generated answer, performance and ability scores of the user before and after the question are obtained at a predetermined frequency from the performance information server 30 (P11). The performance and ability scores are obtained as the state of the user corresponding to the answer. The appropriate frequency may be determined, based on a period in which answers are generated to a predetermined number of times of questions or an interval at which the performance information server 30 obtains results of examinations taken by multiple users, for example. The weights assigned to the external knowledge databases 51 are obtained, based on the cluster of the user who asked the question and received the answer to the question. Based on the correspondence between the weights and the degrees of change (improvement) in performance, the validity of the answer is evaluated (P12). That is, the degree of contribution of each external knowledge database 51 to the degree of change is evaluated, and the validity of the weights assigned to the external knowledge databases 51 is evaluated. The server device 10 adjusts the weights such that the weights better correspond to the degrees of contribution (P13). The server device 10 updates the weight settings stored in the cluster information 132, based on the adjusted weight information (P14).

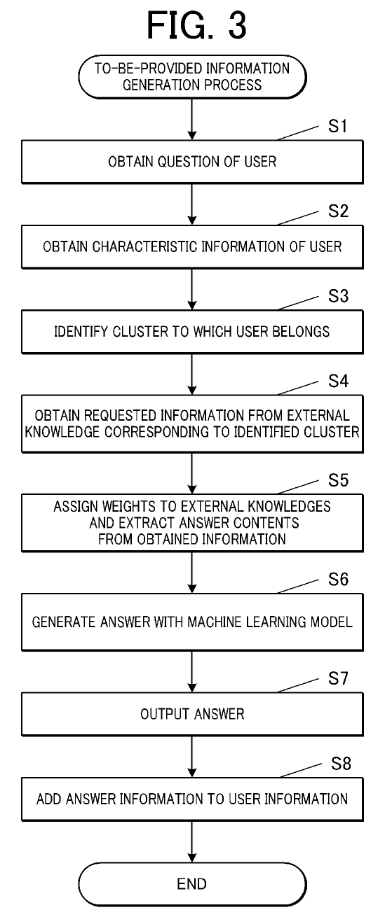

The CPU 11 of the server device 10 performs a process of generating information to be provided to the user by the control procedure shown in FIG. 3. The CPU 11 obtains a question of the user from the user terminal 71 (S1). The CPU 11 refers to the user information 133 to obtain the characteristic information of the user (S2). The CPU 11 identifies the cluster to which the user belongs, based on the characteristic information of the user and, if necessary, information on the field of the question (S3: identification unit). The CPU 11 selects the external knowledge database(s) 51 corresponding to the identified cluster, requests description contents corresponding to the question content from the selected external knowledge database 51, and obtains description contents corresponding to the question content (i.e., obtains requested information) (S4: determination unit). From each of the obtained description contents, the CPU 11 extracts a description (answer contents) that satisfies a criterion of answer contents to the question, according to the weights determined for the cluster (S5: obtaining unit). Descriptions may be extracted by vector search, as described above. The CPU 11 inputs the question content and the extracted answer contents to the machine learning model 1311 to generate an answer (S6: generating unit). The CPU 11 outputs the generated answer to the user terminal 71 from which the question was obtained (S7). The CPU 11 additionally registers the information on the answer in the user information 133 (S8). The CPU 11 then ends the to-be-provided information generation process.

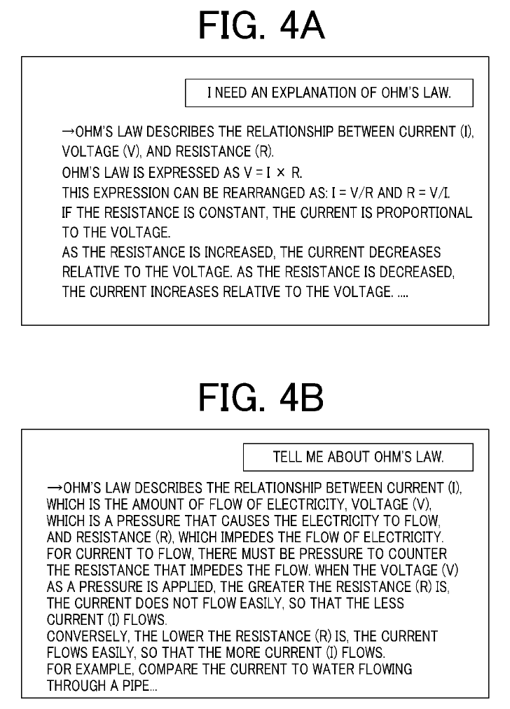

Instead of simply providing a general answer to a question as shown in FIG. 4A, the server device 10 may adjust and output a basic and intuitive answer as shown in FIG. 4B, according to the cluster to which the questioner belongs. Herein, in response to an input that requests an explanation of Ohm's law, the explanation may be provided with examples and without mathematical formulas to encourage basic understanding at the elementary stage.

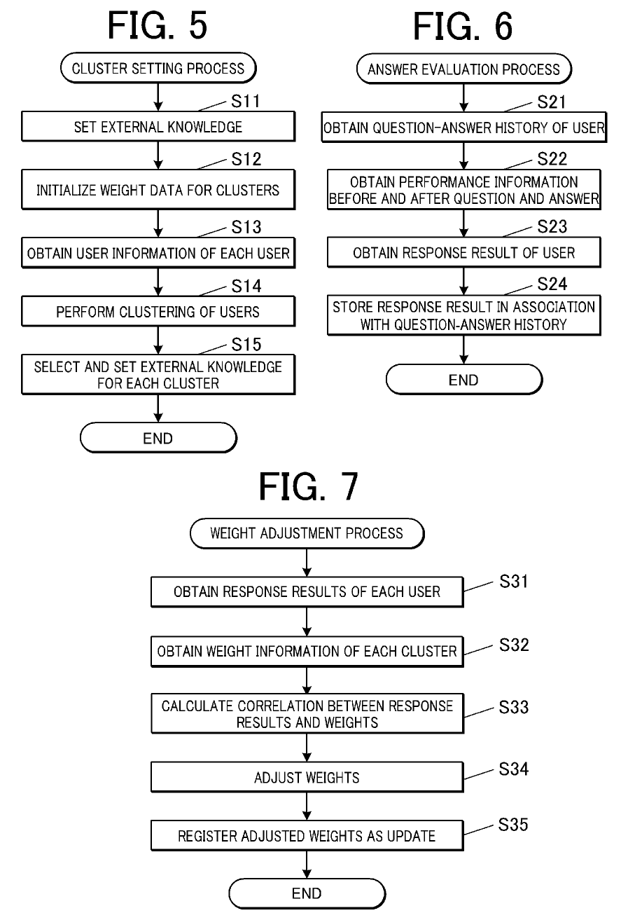

As described above, the clustering setting is done before answers are generated. When the characteristics of individual users change, the characteristics of each user are applied to the set clustering criteria, so that the cluster to which the user belongs is swiftly identified. Thus, the cluster to which the user belongs can change according to improvements in ability of the user. The clustering setting is done by the cluster setting process shown in FIG. 5. Herein, the cluster setting process is performed by the CPU 11 of the server device 10. The cluster setting process may be performed by an external device capable of obtaining the user information 133. The cluster setting process may be performed when external knowledge is updated or added and when the user information of many users is updated or added.

The CPU 11 determines the external knowledge databases 51 from which information is to be obtained in generating answers (S11). The CPU 11 initializes weight data determined for each of the clusters (S12). Initializing weight data may be setting an equal ratio for all the external knowledge databases 51. The CPU 11 obtains user information of users for whom clustering is performed (S13). The user information includes parameters of multiple characteristics, as described above. The CPU 11 performs clustering of the users by the clustering method described above, based on the parameters of the users (S14). Clustering may be the division of the users into a predetermined number of clusters.

For each of the clusters of the predetermined number, the CPU 11 selects and determines external knowledge databases 51 (S15). The selection may be based on inputs and settings by the administrator who reviewed the clustering result. For another example, knowledge levels, ability levels, and so forth may be determined beforehand for the external knowledge databases 51; and based on these levels, the CPU 11 may determine the external knowledge databases 51 for each of the clusters. The CPU 11 assigns zero weight to the external knowledge databases 51 other than the selected external knowledge databases 51. The CPU 11 may assign an equal weight to the selected external knowledge databases 51. That is, at the initial stage of clustering, there may be no difference between the selected external knowledge databases 51 among the clusters. For another example, the CPU 11 may assign initial weights to the respective selected external knowledge databases 51. The CPU 11 then ends the cluster setting process.

After sending an answer to the user, the server device 10 evaluates the effectiveness of the answer at appropriate timing according to an answer evaluation process shown in FIG. 6. As described above, the appropriate timing may be determined based on the number of times of answers or may coincide with the timing when scores of a test (e.g., a regular examination) are registered. The CPU 11 obtains a history of questions and answers of the user in an evaluation target period from the user information 133 (S21).

The CPU 11 obtains performance information immediately before a question and performance information immediately after an answer (S22). The performance information to be obtained includes at least performance in the field of the question. If performance information immediately after an answer is unavailable, the answer may be excluded from the evaluation targets. Based on the obtained performance information before and after the question and the answer, the CPU 11 obtains a change in performance as an evaluation value for evaluating the response result (S23). The CPU 11 stores the evaluation value of the response result in the user information 133 in association with the history of questions and answers (S24). The CPU 11 then ends the answer evaluation process.

The weights initially assigned to the external knowledge databases 51 for each cluster are adjusted by a weight adjustment process shown in FIG. 7, based on the result of the answer evaluation. The CPU 11 obtains the response results regarding questions and answers of each user (S31). The CPU 11 obtains weight information of each cluster (S32).

For each cluster, the CPU 11 calculates the correlation between the response results and the weights (S33). The CPU 11 adjusts the weights set for each cluster to improve response results (S34). The CPU 11 registers the adjusted weights in the cluster information 132, thereby updating the cluster information 132 (S35). The CPU 11 then ends the weight adjustment process.

As described above, the information provision system 100 of this embodiment includes the CPU 11. The CPU 11 identifies the cluster to which the user belongs, based on characteristic information of the user. The CPU 11 determines an external knowledge database 51 corresponding to the identified cluster. The CPU 11 obtains response contents for responding to input contents by the user from the external knowledge database 51. The CPU 11 inputs the obtained response contents into a machine learning model to generate a response to the user. There has been an attempt to select an optimum AI for question contents from multiple AIs and to cause the AI to output an answer. However, if the AI is not compatible with the input question, the AI cannot generate an optimum answer desired by the user. In contrast, the information provision system 100 of the present disclosure can selectively use external knowledge suitable for the characteristics of the user in generating and outputting texts for the user. Thus, in response to various input contents, the information provision system 100 can generate and output precise information that better corresponds to the user. That is, the information provision system 100 contributes to improving the technology of generating and outputting responses. Natural language processing using a machine learning model is currently preferable for generating and outputting natural response texts. By obtaining appropriate knowledge contents from outside as described above, the information provision system 100 itself does not have to train the machine learning model with knowledge. Thus, the information provision system 100 can accurately output a response of an appropriate level to the user while reducing unnaturalness in the text.

Multiple external knowledge databases 51 corresponding to the cluster may be selected. In extracting response contents, the CPU 11 may assign weights to information items obtained from the selected external knowledge databases 51. That is, the information provision system 100 may not only select the external knowledge databases 51 but also combine information items obtained from the external knowledge databases 51 at an appropriate ratio. Such an information provision system 100 can generate more accurate and appropriate responses to questions by the users, based on the descriptions of the questions by the users in addition to the classification of clusters to which the users belong.

The CPU 11 may obtain the user state corresponding to the response (answer), namely a change in performance before and after the response. Based on the relation between the user state and the weights, the CPU 11 may adjust the weights. It is difficult to assign precise weights to the connections between the external knowledge databases 51 and each cluster from the start. By evaluating how a response actually influenced the user, the information provision system 100 can precisely adjust the selection of the external knowledge databases 51 and the weights assigned thereto.

The characteristic information may also include a history of inputs by the user. Since the characteristics of input texts of each user are taken into account as well as their performance, achievements, and status, it is possible to generate response contents that better reflect the user state, such as the level of understanding and desire for improvement.

The characteristic information may also include an ability score of the user in the field corresponding to the input contents, such as performance in tests or competitions. By determining the cluster of the user based on the ability of the user, the information provision system 100 can provide appropriate information at a necessary level (i.e., comprehensible and practicable information) for the user.

The input content by the user may be a question, and the response may be an answer based on the answer contents obtained from the determined external knowledge. That is, the information provision system 100 may generate an answer to a question. By obtaining the answer contents from the external knowledge selected based on the user characteristics and generating an answer at a level expected by the user, the information provision system 100 meets the requests of the user and contributes to improving his/her ability and motivation.

The CPU 11 may obtain, as an evaluation value, a change between (i) performance information in the field corresponding to the question of the user before the question is input and (ii) performance information in the field after an answer to the question is generated. The CPU 11 may associate the obtained evaluation value with user information of the user. Thus, the information provision system 100 can quantitatively evaluate how much the answer contributed to improving performance. By reflecting such evaluations in generating answers, the information provision system 100 can accurately generate suitable answers to the user.

The information provision method of the embodiment includes: (1) identifying the cluster to which the user belongs, based on the characteristic information of the user; (2) determining the external knowledge database(s) 51 corresponding to the identified cluster; (3) obtaining response contents to the content input by the user from the determined external knowledge database(s) 51; and (4) generating a response to the user using the obtained response contents. According to this information provision method, it is possible to accurately generate an appropriate response to the user. Thus, according to the information provision method, it is possible to improve understanding and desire for improvement of the user in the field related to the response. Further, the program 131 of the above information provision method can be installed in and executed by a computer, so that accurate information can be provided without specially configured hardware.

The above embodiment is not intended to limit the present disclosure and can be variously modified. For example, although text portions related to the question content are extracted from the external knowledge database 51 by vector search in the above, the present disclosure is not limited to this. Text portions related to the question content may be extracted by a different method, such as keyword search or semantic search. Text portions may also be extracted by hybrid search in which keyword search and vector search are combined.

Although the input history of questions is considered in generating an answer in the above, the input history may not be considered. The information provision system 100 can adjust answer contents to a question each time, as long as the system 100 recognizes the performance of the user in the field or the state of the user stagnating at the same level. For another example, changes in performance or ability resulting from individual questions may not be considered.

Although the weights are adjusted based on changes in objective values (e.g., performance) before and after an answer to the user question, the present disclosure is not limited to this. The subjective evaluation of the answers by the user may be reflected in the weight adjustment. That is, the user may numerically evaluate how comprehensible and satisfactory an answer is, and the user terminal 71 may receive the numerical evaluation input by the user. Further, although the generated answers are limited to text data in the above, the answers are not limited to texts. The information provision system 100 may also be able to output charts or other forms of information that are necessary for explanation or that can facilitate understanding. Further, although questions by the user are received in the above, the contents to be received may not be questions. For example, when contents like the thoughts or feelings of the user are input, some advice may be generated as response texts to the input.

In the above, a single server device 10 performs setting of a cluster for the user, selection of the external knowledge databases 51, the process of extracting response contents from information obtained from the external knowledge databases 51, and generation of an answer with the machine learning model 1311. However, part or all of these processes may be performed by a different information processing device(s). That is, when receiving a question input by the user, the server device 10 may request the information processing device to execute these processes by providing necessary information and may obtain the processing result. Further, in the above, the storage 13 including a nonvolatile memory (e.g., HDD and flash memory) is used as an example of a computer-readable medium that stores the program 131 related to controlling generation of information to be provided according to the present disclosure. However, the computer-readable medium is not limited to this. As other computer-readable non-transitory storage media, other nonvolatile memories (e.g., magnetoresistive RAM (MRAM)) and portable storage media (e.g., CD-ROM, DVD) are applicable. Further, as a medium to provide data of the program according to the present disclosure via a communication line, a carrier wave is also applicable. The detailed configuration and detailed contents and procedure of processing operations described in the above embodiment can be appropriately modified without departing from the scope of the present disclosure. The scope of the present invention encompasses the scope of the disclosure recited in the claims and the equivalent thereof.

1. An information provision system comprising a processor that:
identifies a group to which a user belongs, based on characteristic information of the user,
determines external knowledge data corresponding to the identified group,
obtains a response content for responding to an input content by the user from the determined external knowledge data, and
inputs the obtained response content to a machine learning model to generate a response to the user.

2. The information provision system according to claim 1, wherein:
the processor determines multiple sets of external knowledge data corresponding to the group, and
the processor assigns weights to information items obtained from the determined sets of external knowledge data and extracts response contents from the information items.

3. The information provision system according to claim 2, wherein:
the processor obtains a state of the user corresponding to the response, and
the processor adjusts the weights, based on a relation between the state of the user and the weights.

4. The information provision system according to claim 1, wherein the characteristic information includes a history of inputs by the user.

5. The information provision system according to claim 1, wherein the characteristic information includes an ability score of the user in a field corresponding to the input content.

6. The information provision system according to claim 1, wherein:
the input content by the user is a question, and
the response is an answer based on an answer content obtained from the determined external knowledge data.

7. The information provision system according to claim 6, wherein:
the processor obtains an evaluation value that is a change from (i) performance information of the user in a field corresponding to the question before the question is input to (ii) performance information of the user in the field after the answer to the question is generated, and
the processor associates the obtained evaluation value with the characteristic information of the user.

8. An information provision method that causes a computer to:
identify a group to which a user belongs, based on characteristic information of the user,
determine external knowledge data corresponding to the identified group,
obtain a response content for responding to an input content by the user from the determined external knowledge data, and
input the obtained response content to a machine learning model to generate a response to the user.

9. A non-transitory computer-readable storage medium storing a program that causes a computer to:
identify a group to which a user belongs, based on characteristic information of the user,
determine external knowledge data corresponding to the identified group,
obtain a response content for responding to an input content by the user from the determined external knowledge data, and
input the obtained response content to a machine learning model to generate a response to the user.
